(19) United States
(12) Patent Application Publication
(10) Pub. No.: US 2025/0165821 A1
(43) Pub. Date: May 22, 2025

(54) METHOD FOR MAKING THE FUNCTION OF A MACHINE LEARNING ALGORITHM EXPLAINABLE

(71) Applicant: Robert Bosch GmbH, Stuttgart (DE)

(72) Inventors: Andreas Steimer, Schoemberg (DE); Clint Sebastian, Stuttgart (DE); Jana Veser, Dannstadt-Schauernheim (DE); Laura Beggel, Stuttgart (DE); Thi Phuong Nhung Ngo, Karlsruhe-Neureut (DE); Mehul Bansal, Sindelfingen (DE)

(21) Appl. No.: 18/937,621

(22) Filed: Nov. 5, 2024

(30) Foreign Application Priority Data
Nov. 17, 2023 (DE) 10 2023 211 441.0

(51) Int. Cl. G06N 5/045

(52) U.S. Cl. CPC G06N 5/045

(57) ABSTRACT

A method for making the function of a machine learning algorithm explainable, wherein the machine learning algorithm is designed to assign input data to one of at least two groups. The method includes: providing input data for the machine learning algorithm; for all of the input data provided, assigning the corresponding input data to one of the at least two groups by means of the machine learning algorithm; selecting data from a first group of the at least two groups; ascertaining, from a second group of at least two groups, data that are most similar to the selected data from all the data contained in the second group; comparing the selected data with the ascertained data to make the machine learning algorithm explainable; and providing corresponding comparison results.

### CROSS REFERENCE

The present application claims the benefit under 35 U.S.C. § 119 of German Patent Application No. DE 10 2023 211 441.0 filed on Nov. 17, 2023, which is expressly incorporated herein by reference in its entirety.

### FIELD

The present invention relates to a method for making the function of a machine learning algorithm explainable, with which the function of a machine learning algorithm can be made explainable or understandable in a simple manner and with comparatively low resource consumption.

### BACKGROUND INFORMATION

Machine learning algorithms are based on using statistical methods to train a data processing system in such a way that it can perform a particular task without it being originally programmed explicitly for this purpose. The goal of machine learning is to construct algorithms that can learn and make predictions from data. These algorithms create mathematical models by means of which data can be classified, for example.

Machine learning algorithms include, for example, classification methods. Classification methods are methods that describe an assignment or grouping of observations into predefined categories.

Such classification methods are used, for example, in methods for detecting anomalies on the surface of a product produced by a manufacturing process. An example of such methods is automatic inspection, which is designed to detect defects in corresponding products using image processing methods.

It is often desired to make the function of a machine learning algorithm explainable or understandable, for example in order to increase trust in the corresponding machine learning algorithm and/or to optimize it accordingly.

For example, it is conventional to generate artificial counterfactual examples, on the basis of which the function of a machine learning algorithm is to be made explainable. However, the generation of artificial counterfactual examples is associated with a comparatively high consumption of resources, for example a large consumption of memory and/or processor capacities. In addition, the quality of the generated artificial counterfactual examples is often limited.

European Patent Application No. EP 3 796 228 A1 describes a method for generating counterfactual examples for neural networks.

### SUMMARY

An object of the present invention is to provide an improved method for making a machine learning algorithm explainable.

The object may be achieved by a method for making a machine learning algorithm explainable according to certain features of the present invention.

The object may also achieved by a system for making a machine learning algorithm explainable according to certain features of the present invention.

According to an example embodiment of the present invention, the object may be achieved by a method for making the function of a machine learning algorithm explainable, wherein the machine learning algorithm is designed to assign input data to one of at least two groups, and wherein the method comprises: providing input data for the machine learning algorithm; for all of the input data provided, assigning the corresponding input data to one of the at least two groups by means of the machine learning algorithm; selecting data from a first group of the at least two groups; ascertaining, from a second group of the at least two groups, data that are most similar to the selected data from all the data contained in the second group; comparing the selected data with the ascertained data in order to make the machine learning algorithm explainable; and providing corresponding comparison results.

Input data here are understood to mean to data that are assigned by the machine learning algorithm into corresponding output data or output values, i.e., in particular to one of at least two groups, in particular corresponding sensor data.

Thus, a method for making the function of a machine learning algorithm explainable is provided, which is based on ascertaining the data that are most similar to each other from different groups, wherein the differences between the assignment of data into the corresponding groups can be indicated by comparing these data.

Consequently, the present invention provides a method for making the function of a machine learning algorithm explainable, with which high-quality counterfactual examples can be generated, but which does not require the generation of an artificial counterfactual example, that is, a method with which the function of a machine learning algorithm can be made explainable in a simple manner and with comparatively low resource consumption.

Overall, an improved method for making a machine learning algorithm explainable is thus provided.

In one example embodiment of the present invention, the step of ascertaining, from the second group, data that are most similar to the selected data comprises applying at least one encoder.

Encoders or autoencoders are machine learning algorithms that are designed to extract certain features from data and make complex data understandable.

Thus, the similar data can be ascertained in a simple manner on the basis of conventional machine learning algorithms, without the need for complex and resource-intensive adjustments.

In addition, according to an example embodiment of the present invention, the method can further comprise retraining the machine learning algorithm on the basis of the comparison results. In particular, the vulnerabilities of the corresponding machine learning algorithm can be uncovered and remedied in a simple manner and with comparatively low resource consumption. The input data can also comprise sensor data.

A sensor, which is also referred to as a detector, (measured variable or measuring) pickup or (measuring) probe, is a technical component which can detect certain physical or chemical properties and/or the material nature of its surroundings qualitatively or quantitatively as a measured variable.

Circumstances outside the data processing system on which the method is carried out can thus be taken into account and incorporated into making the function of the machine learning algorithm explainable.

For example, the machine learning algorithm can be a machine learning algorithm for the automatic optical inspection of products produced by a manufacturing process, wherein the input data are image data, captured by a sensor, of products produced by the manufacturing process.

A manufacturing process is generally understood to mean a standardized workflow in which a product is produced using predetermined manufacturing processes, work equipment and resources by mechanical and/or manual processing of raw materials or intermediate products. Depending on the comparison results, the aforementioned manufactured products can either be discarded and thus not further processed, or approved for subsequent processing steps.

In particular with automatic optical inspection methods, it is important to understand how they work and thus to make them explainable.

A further example embodiment of the present invention also provides a system for making the function of a machine learning algorithm explainable, wherein the machine learning algorithm is designed to assign input data to one of at least two groups, and wherein the system comprises: a first provision unit that is designed to provide input data for the machine learning algorithm; an assignment unit that is designed, for all of the input data provided, to assign the corresponding input data to one of the at least two groups by means of the machine learning algorithm; a selection unit that is designed to select data from a first group of the at least two groups; an ascertainment unit that is designed to ascertain, from a second group of the at least two groups, data that are most similar to the selected data from all the data contained in the second group; a comparison unit that is designed to compare the selected data with the ascertained data in order to make the machine learning algorithm explainable; and a second provision unit that is designed to provide corresponding comparison results.

An improved system for making a machine learning algorithm explainable is thus provided by the present invention. In particular, a system for making the function of a machine learning algorithm explainable is provided, with which high-quality counterfactual examples can be generated, but which does not require the generation of an artificial counterfactual example, that is, a system with which the function of a machine learning algorithm can be made explainable in a simple manner and with comparatively low resource consumption.

In one example embodiment of the present invention, the ascertainment unit is designed to apply at least one encoder to ascertain the data. Thus, the similar data can be ascertained in a simple manner on the basis of conventional machine learning algorithms, without the need for complex and resource-intensive adjustments.

In addition, according to an example embodiment of the present invention, the system can further comprise a retraining unit that is designed to retrain the machine learning algorithm on the basis of the comparison results. In particular, the vulnerabilities of the corresponding machine learning algorithm can be uncovered and remedied in a simple manner and with comparatively low resource consumption.

The input data can also comprise sensor data. Circumstances outside the data processing system on which the method is carried out can thus be taken into account and incorporated into making the function of the machine learning algorithm explainable.

For example, the machine learning algorithm can be a machine learning algorithm for the automatic optical inspection of products produced by a manufacturing process, wherein the input data are image data, captured by a sensor, of products produced by the manufacturing process. In particular with automatic optical inspection methods, it is important to understand how they work and thus to make them explainable.

With a further example embodiment of the present invention, a computer program is also provided, comprising program code for carrying out an above-described method of the present invention for making the function of a machine learning algorithm explainable when the computer program is executed on a computer.

With a further example embodiment of the present invention, a computer-readable data carrier is also provided, comprising program code of a computer program for carrying out an above-described method of the present invention for providing training data to make the function of a machine learning algorithm explainable when the computer program is executed on a computer.

The computer program and the computer-readable data carrier of the present invention each have the advantage of being designed to carry out an improved method for making a machine learning algorithm explainable according to the present invention. In particular, they are designed to carry out a method for making the function of a machine learning algorithm explainable, with which high-quality counterfactual examples can be generated, but which does not require the generation of an artificial counterfactual example, that is, a method with which the function of a machine learning algorithm can be made explainable in a simple manner and with comparatively low resource consumption.

In summary, it can be stated that the present invention provides a method for making the function of a machine learning algorithm explainable, with which the function of a machine learning algorithm can be made explainable in a simple manner and with comparatively low resource consumption.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a flowchart of a method for making the function of a machine learning algorithm explainable according to example embodiments of the present invention.

FIG. 2 is a schematic block diagram of a system for making the function of a machine learning algorithm explainable according to example embodiments of the present invention.

In the figures, identical reference signs denote identical or functionally identical elements, parts or components, unless stated otherwise.

### DETAILED DESCRIPTION OF EXAMPLE EMBODIMENTS

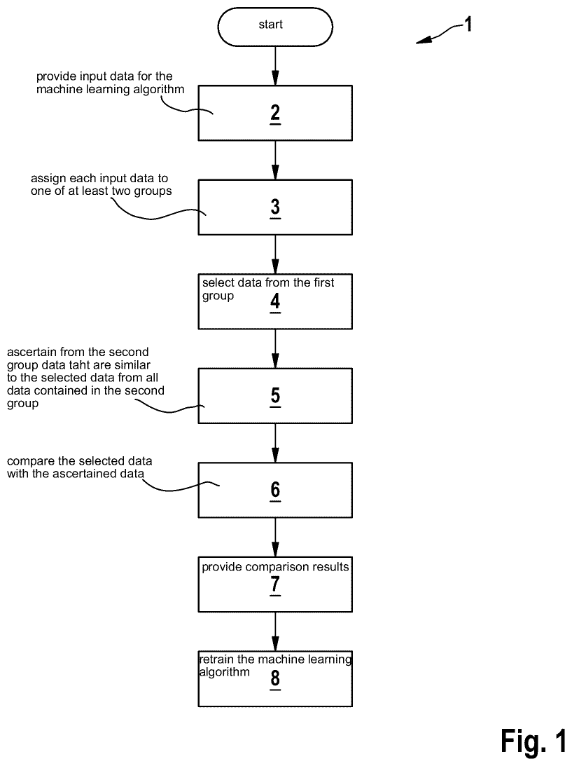

FIG. 1 shows a flowchart of a method for ascertaining at least one change point in a time series of sensor values 1 according to example embodiments of the present invention.

Machine learning algorithms include, for example, classification methods. Classification methods are methods that describe an assignment or grouping of observations into predefined categories.

Such classification methods are used, for example, in methods for detecting anomalies on the surface of a product produced by a manufacturing process. An example of such methods is automatic inspection, which is designed to detect defects in corresponding products using image processing methods.

It is often desired to make the function of a machine learning algorithm explainable or understandable, for example in order to increase trust in the corresponding machine learning algorithm and/or to optimize it accordingly.

For example, it is conventional to generate artificial counterfactual examples, on the basis of which the function of a machine learning algorithm is to be made explainable. However, the generation of artificial counterfactual examples is associated with a comparatively high consumption of resources, for example a large consumption of memory and/or processor capacities. In addition, the quality of the generated artificial counterfactual examples is often limited.

FIG. 1 shows a method for making the function of a machine learning algorithm explainable 1, wherein the machine learning algorithm is designed to assign input data to one of at least two groups, and wherein the method 1 comprises a step 2 of providing input data for the machine learning algorithm; a step 3 of, for all of the input data provided, assigning the corresponding input data to one of the at least two groups by means of the machine learning algorithm; a step 4 of selecting data from a first group of the at least two groups; a step 5 of ascertaining, from a second group of the at least two groups, data that are most similar to the selected data from all the data contained in the second group; a step 6 of comparing the selected data with the ascertained data in order to make the machine learning algorithm explainable; and a step 7 of providing corresponding comparison results.

Consequently, a method for making the function of a machine learning algorithm explainable 1 is provided, with which high-quality counterfactual examples can be generated, but which does not require the generation of an artificial counterfactual example, that is, a method with which the function of a machine learning algorithm can be made explainable in a simple manner and with comparatively low resource consumption.

Overall, an improved method for making a machine learning algorithm explainable 1 is thus provided.

In particular, FIG. 1 shows a method 1 in which a counterfactual example by ascertaining data from one class that are most similar to selected data from another class.

The step 4 of selecting data from the first group of the at least two groups can comprise a random selection of data, or a selection of data on the basis of corresponding specifications, for example application-specific specifications.

According to the embodiments of FIG. 1, the step of ascertaining, from the second group, data that are most similar to the selected data comprises applying at least one encoder.

In particular, feature vectors can be formed on the basis of the selected data and all elements of the second group, and the data similar to the selected data can be ascertained on the basis of these feature vectors.

As shown in FIG. 1, the method 1 further comprises a step 8 of retraining the machine learning algorithm on the basis of the comparison results.

In particular, the method 1 is designed to evaluate the model quality and to optimize the machine learning algorithm accordingly.

The input data again also comprise sensor data.

According to the embodiments of FIG. 1, the machine learning algorithm is in particular a machine learning algorithm for the automatic optical inspection of products produced by a manufacturing process, wherein the input data are image data, captured by a sensor, of products produced by the manufacturing process.

The selected data can in particular be data that have been classified as non-OK, i.e., containing errors or exhibiting an anomaly, with the data that are classified as OK and are most similar to this data being ascertained.

On the basis of corresponding classification results, products classified as non-OK by the machine learning algorithm can also be automatically discarded.

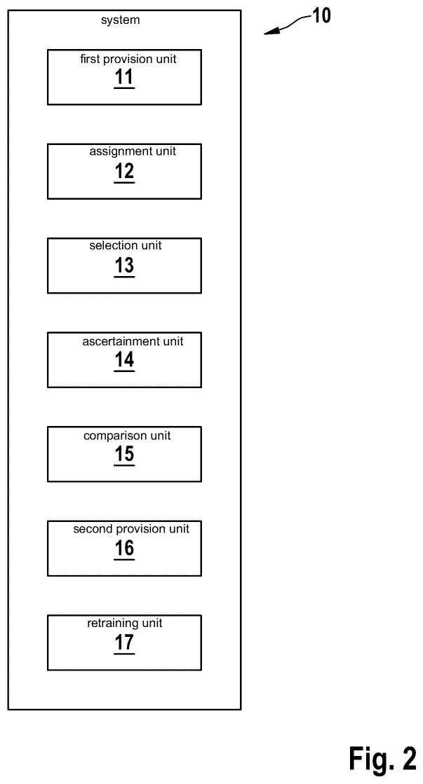

FIG. 2 shows a schematic block diagram of a system for ascertaining at least one change point in a time series of sensor values 10 according to embodiments of the present invention.

In particular, FIG. 2 shows a system for making the function of a machine learning algorithm explainable 10, wherein the machine learning algorithm is designed to assign input data to one of at least two groups, and wherein the system 10 comprises: a first provision unit 11 that is designed to provide input data for the machine learning algorithm; an assignment unit 12 that is designed, for all of the input data provided, to assign the corresponding input data to one of the at least two groups by means of the machine learning algorithm; a selection unit 13 that is designed to select data from a first group of the at least two groups; an ascertainment unit 14 that is designed to ascertain, from a second group of the at least two groups, data that are most similar to the selected data from all the data contained in the second group; a comparison unit 15 that is designed to compare the selected data with the ascertained data in order to make the machine learning algorithm explainable; and a second provision unit 16 that is designed to provide corresponding comparison results.

The first provision unit can in particular be a receiver that is designed to receive corresponding data, in particular sensor data. The second provision unit can also be a transmitter that is designed to transmit corresponding information or data. The first provision unit and the second provision unit can furthermore also be integrated into a common transceiver.

The assignment unit, the selection unit, the ascertainment unit and the comparison unit can also each be realized, for example, on the basis of a code that is stored in a memory and can be executed by a processor.

According to the embodiments of FIG. 2, the ascertainment unit 14 is further designed to apply at least one encoder to ascertain the data.

As FIG. 2 further shows, the system 10 further has a retraining unit 17 that is designed to retrain the machine learning algorithm on the basis of the comparison results.

The retraining unit can again be realized, for example, on the basis of a code that is stored in a memory and can be executed by a processor.

Furthermore, the input data again comprise sensor data.

According to the embodiments of FIG. 2, the machine learning algorithm is in particular again a machine learning algorithm for the automatic optical inspection of products produced by a manufacturing process, wherein the input data are image data, captured by a sensor, of products produced by the manufacturing process.

In addition, the system 10 shown is designed to carry out an above-described method for making the function of a machine learning algorithm explainable.

What is claimed is:

1. A method for making the function of a machine learning algorithm explainable, the machine learning algorithm being configured to assign input data to one of at least two groups, the method comprising the following steps:
providing input data for the machine learning algorithm;
for all of the input data provided, assigning each respective input data to one of the at least two groups using the machine learning algorithm;
selecting data from a first group of the at least two groups;
ascertaining, from a second group of at least two groups, data that are most similar to the selected data from all the data contained in the second group;
comparing the selected data with the ascertained data to make the machine learning algorithm explainable; and
providing comparison results based on the comparing.

2. The method according to claim 1, wherein the step of ascertaining, from the second group, the data that are most similar to the selected data including applying at least one encoder.

3. The method according to claim 1, wherein the method further comprises the following step:
retraining the machine learning algorithm based on the comparison results.

4. The method according to claim 1, wherein the input data include sensor data.

5. The method according to claim 4, wherein the machine learning algorithm is a machine learning algorithm for an automatic optical inspection of products produced by a manufacturing method, and wherein the input data are image data, captured by a sensor, of products produced by the manufacturing method.

6. A system for making the function of a machine learning algorithm explainable, the machine learning algorithm being configured to assign input data to one of at least two groups, the system comprising:
a first provision unit configured to provide input data for the machine learning algorithm;
an assignment unit configured to, for all of the input data provided, to assign each respective input data to one of the at least two groups using the machine learning algorithm;
a selection unit configured to select data from a first group of the at least two groups;
an ascertainment unit configured to ascertain, from a second group of the at least two groups, data that are most similar to the selected data from all the data contained in the second group;
a comparison unit configured to compare the selected data with the ascertained data in order to make the machine learning algorithm explainable; and
a second provision unit configured to provide comparison results based on the comparing.

7. The system according to claim 6, wherein the ascertainment unit is configured to apply at least one encoder to ascertain the data.

8. The system according to claim 6, further comprises:
a retraining unit configured to retrain the machine learning algorithm based on the comparison results.

9. A non-transitory computer-readable data carrier on which is stored program code of a computer program for making the function of a machine learning algorithm explainable, the machine learning algorithm being configured to assign input data to one of at least two groups, the program code, when executed by a computer, causing the computer to perform the following steps:
providing input data for the machine learning algorithm;
for all of the input data provided, assigning each respective input data to one of the at least two groups using the machine learning algorithm;
selecting data from a first group of the at least two groups;
ascertaining, from a second group of at least two groups, data that are most similar to the selected data from all the data contained in the second group;
comparing the selected data with the ascertained data to make the machine learning algorithm explainable; and
providing comparison results based on the comparing.
